(19) United States
(12) Patent Application Publication
(10) Pub. No.: US 2017/0308929 A1
(43) Pub. Date: Oct. 26, 2017

(54) Social Network Based Advertisement

(71) Applicant: Chian Chiu Li, Fremont, CA (US)

(72) Inventor: Chian Chiu Li, Fremont, CA (US)

(21) Appl. No.: 15/344,555

(22) Filed: Nov. 6, 2016

Related U.S. Application Data
(60) Provisional application No. 62/326,839, filed on Apr. 25, 2016.
(60) Provisional application No. 62/339,927, filed on May 22, 2016.
(60) Provisional application No. 62/358,158, filed on Jul. 5, 2016.

(51) Int. Cl. G06Q 30/02; H04W 4/02; H04M 1/725; G06F 17/30; G06Q 50/00; H04W 4/18

(52) U.S. Cl. CPC G06Q 30/0259; H04W 4/185; H04W 4/02; H04M 1/72583; G06F 17/30312; G06Q 50/01; G06Q 30/0277; H04M 1/72547

(57) ABSTRACT

Systems and methods for advertisement using location-based open social networking circles. The circles are arranged for businesses respectively. After a user launches circle app at user device, icons of nearby business circles show up in app interface. The icons each display a circle name and a short ad message. A short ad message presented in app interface is created and controlled by a business directly and independently. In an aspect, a short ad message entered by a business in circle interface appears in app interface for public use in real time. In another aspect, contents arranged in circle interface by a business are collected and become searchable for users. In yet another aspect, circle app is arranged to check a designated file at a business or a business' website and update contents in circle interface automatically.

### CROSS REFERENCE TO RELATED APPLICATION

This application claims the benefit under 35 U.S.C. Sec. 119 of provisional patent applications Ser. No. 62/326,839, filed Apr. 25, 2016, Ser. No. 62/339,927, filed May 22, 2016, and Ser. No. 62/358,158, filed Jul. 5, 2016.

### FEDERALLY SPONSORED RESEARCH

Not applicable

### SEQUENCE LISTING OR PROGRAM

Not applicable

### BACKGROUND

### Field of Invention

This invention relates to advertising, and more specifically, to advertising utilizing location-based open social networks.

### Description of Prior Art

A social networking system provides an online service, platform, or website that implements social networks or social networking circles, where users may share news, information, ideas, or feelings. A social networking environment is mostly web-based, and it enables users to interact with each other over the Internet, via online posts, instant or short messages, tweets, or emails. As smartphone system supports social networking environment and many users have a smartphone, social network may work as an effective communication platform. For many businesses, like retail and online store, restaurant, service, organization, and agency, social network may work as a platform for advertisement as well. For instance, a business may design a circle interface to present products, promotions, ads, contact info, etc.

It is relatively straightforward to convert a circle interface into an advertising platform, as an interface may display various contents in many ways. But it's not easy for business to attract users to visit a circle interface and view contents in there. It is also not easy for users to find wanted advertisement info, given the fact that there are too many competing businesses in a networking system.

Therefore, in a social networking environment, there exists a need for business to present advertisement info effectively and a need for user to find needed advertisement info conveniently.

The word “post” as verb or “posting” is referred broadly as transmitting information from a user to a server via communication network to let others in certain environment, such as a social networking circle, access the transmitted information. The word “post” as noun includes information posted or submitted by a user on the Internet, or user generated content on the Internet or in any network. Posted information or contents may cover a hyperlink or a uniform resource locator (URL), audio, video, an image, a text, a message, an e-mail, news article, blog entry, survey, etc. Posts are preferably hosted on a web site, but may also be hosted locally using local database or local server system. In discussions below, messages, besides posts, are used sometime. “Message” as noun is considered equivalent to post.

### OBJECTS AND ADVANTAGES

Accordingly, several main objects and advantages of the present invention are:

a). to provide an improved advertising method using location-based open social networks;

b). to provide such a method which presents ads of nearby businesses;

c). to provide such a method which presents short ad massages of nearby businesses in networking interface;

d). to provide such a method which enables business to access users who are close by;

e). to provide such a method which enables users to view short ad messages from nearby businesses;

f). to provide such a method which enables businesses to advertise easily, independently, and directly; and

g). to provide such a method which enables businesses to present ads or change ad content in real time.

Further objects and advantages will become apparent from a consideration of the drawings and ensuing description.

### SUMMARY

In accordance with the present invention, advertising methods and systems are proposed using location-based open social networks. Each business may have its own open networking circle. A business may use circle interface as an advertising place for products and services. A circle interface may also provide an ad window where a business may enter a short ad message. The short ad message, once submitted, may be presented to users who are close by in real time. Short ad messages are presented using app interface. For users, it provides a chance to view promotions from nearby merchants. For businesses, it provides a chance to present and manage advertisement easily, directly, freely, and without any middleman. Moreover, info may be collected from circle interface of each business and become searchable for users.

### DRAWING FIGURES

FIG. 1 is an exemplary block diagram describing a user device embodiment in accordance with the present invention.

FIG. 2 is an exemplary flow diagram showing embodiments of presenting ads and accessing store circle in accordance with the present invention.

FIGS. 3 and 4 are graphic diagrams depicting embodiments of circle app interface, where social circles and short ad messages are displayed in map and text modes respectively in accordance with the present invention.

FIGS. 5, 6, and 7 use exemplary flow diagrams to show embodiments of displaying store circles and short ad messages in app interface and accessing store circle interface in accordance with the present invention.

FIG. 8 uses graphic diagrams to show accessing a store circle via an interactive map in accordance with the present invention.

FIG. 9 is a graphic diagram displaying an embodiment of circle app interface, where each circle icon contains multiple lines of messages in accordance with the present invention.

FIGS. 10-A, 10-B, and 10-C each show a schematic flow diagram which depicts process to obtain a search result in accordance with the present invention.

FIG. 11 is an exemplary flow diagram which shows an embodiment of assisted process to build a store circle interface in accordance with the present invention.

REFERENCE NUMERALS IN DRAWINGS

| | | | |
|---|---|---|---|
| 10 | Camera | 12 | Device |
| 14 | Processor | 16 | Computer Readable Medium |
| 18 | GPS Sensor | 20 | NFC Sensor |
| 22 | Screen | 24 | Icon |
| 26 | Icon | 28 | Icon |
| 30 | Icon | 32 | Smartphone |
| 34 | Device | 36 | Screen |
| 38 | Icon | 40 | Icon |
| 42 | Icon | 44 | Device |

100, 102, 104, 106, 108, 110, 112, 114, 116, 118, 120, 124, 126, 128, 130, 132, 134, 136, 138, 140, 142, 144, 146, 148, 150, 152, 154, 156, 158, 160, 162, 164, 166, 168, 170, 172, 174, 176, 178, 180, 182, 184, 186, 188, and 190 are exemplary steps.

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types.

A social networking environment may involve a networking system and multiple user devices. A networking system may contain multiple servers. User devices and network system are connected via communication networks. One or more social networks may be implemented by the networking system in the environment.

The word “server” means a system or systems which may have similar functions and capacities as one or more servers. Main components of server may include one or more processors, which control and process data and information by executing software, logic, code, or stored executable instructions, or carrying out any other suitable functions. A server and/or processor, as a computing device, may include any hardware, firmware, software, or a combination. In the most compact form, thanks to the advance of microelectronic technologies, a server may be built on a single processor chip.

A networking system may enable and implement various types of social networks serving a great number of users. It may exemplarily be divided into three blocks, represented by server, database, and router and switch. A server may comprise one or more servers processing applications, web applications, images, emails, networking, searching tasks, etc. The database may store data associated with users, networks, servers, and various services. Router and switch may transmit information packets between user device and networking system over communication networks and work as a gatekeeper to and from the networks. As social networks may involve a tremendous amount of data, which may be uploaded and aggregated by networking system continuously, a separate database system may be created. A database system may include a large number of storage devices or modules and specialty servers for data management and maintenance.

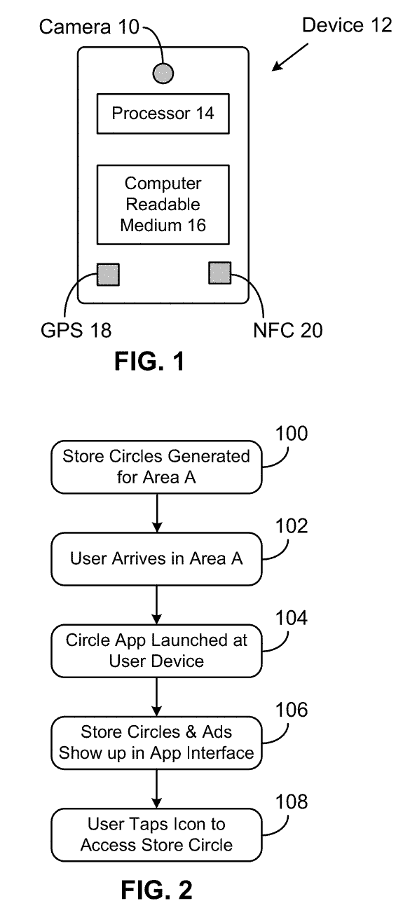

FIG. 1 is an illustrative block diagram of one embodiment according to the present invention. A device 12 may represent user device or a wireless electronic device, including but not limited to mobile phone, smart phone, smart watch, other wearable device, handheld computer, tablet computer, desktop computer, virtual reality (VR) device, augmented reality (AR) device, and the like. Device 12 may include a processor 14 and computer readable medium 16. Processor 14 may mean one or more processor chips or systems. Medium 16 may include a memory hierarchy built by one or more memory chips or storage modules like RAM, ROM, FLASH, magnetic, optical and/or thermal storage devices. Processor 14 may run programs or sets of executable instructions stored in medium 16 for performing various functions and tasks, e.g., surfing on the Internet, placing phone calls, logging on a website, playing video or music, gaming, electronic payment, social networking, survey, sending and receiving emails, short messages, files, and data, executing other applications, etc. Device 12 may also include input, output, and communication components, which may be individual modules or integrated with processor 14. Communication components may connect the device to a server or another device via communication network. Usually, Device 12 may have a display (not shown in FIG. 1 for brevity reason) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, tablet computer, smart watch, and certain wearable devices. A touch screen may be used as a convenient tool for user to enter input and interact with a system.

Furthermore, device 12 may have a voice recognition component to receive user's verbal command or audio input. In addition, device 12 may have a gesture detection mechanism to receive user's gesture instructions. For VR and AR devices and some wearable devices, virtual screen or screen having a very small size may be arranged. While it is inconvenient or impractical to touch such a screen, verbal command and gesture instructions may become useful for users. In discussions below, word “screen” may include virtual screen and screen with very small size, like smaller than one inch by one inch square or even smaller than a fingertip. A networking app interface or networking circle interface may be displayed on all kinds of screens.

A communication network which device 12 may access may cover a range of entities such as the Internet or the World Wide Web, a local area network (LAN), a wide area network (WAN), a metropolitan area network (MAN), a telephone network, an intranet, wireless, and other types of networks. Device 12 may be connected to a network by various wired, wireless, optical, infrared, ultrasonic or other communication means. Via communication networks, device 12 may communicate with a remote server of networking system or service center to send and receive data or messages.

Device 12 may include a camera sensor 10. Sensor 10 may be a regular phone camera module used by user to take pictures in daily life. The camera sensor may be arranged to scan quick response (QR) code, one-dimensional barcode, or any other machine-readable code with the help of certain application. QR code or barcode may be printed out and displayed for public use easily.

Device 12 may include a global positioning system (GPS) 18. Sensor 18 may enable a device to get its own location info. Besides GPS, device location may also be obtained using wireless triangulation methods, or other suitable technology, which may be prepared by a service provider or on-site service facility. Usually for indoor or some urban environment, positioning methods other than GPS are used, since GPS requires a clear view of the sky or clear line of sight for four GPS satellites.

Furthermore, device 12 may have near-field communication (NFC) capability enabled by NFC sensor 20. NFC is of short-range wireless communication technology and may be employed to communicate securely between NFC devices. Sensor 20 may also be used to read radio-frequency identification (RFID) tag. RFID is also a wireless technology for the purpose of data transfer, such as transfer of identification data, passively or actively. A RFID chip or RFID tag may be made very small in size, e.g., smaller or much smaller than one millimeter. It may be manufactured by semiconductor technologies. In application, a RFID tag may be conveniently placed, for instance, on a table or wall for public use.

Inside device 12, output signals of sensors may be transmitted to processor 14, which, employed with certain algorithm, may process the data and act according to predefined programs. For instance, processor 14 may process data from NFC sensor 20, transmit certain messages to a networking system or service center, and then wait for instructions or new messages from the system or center.

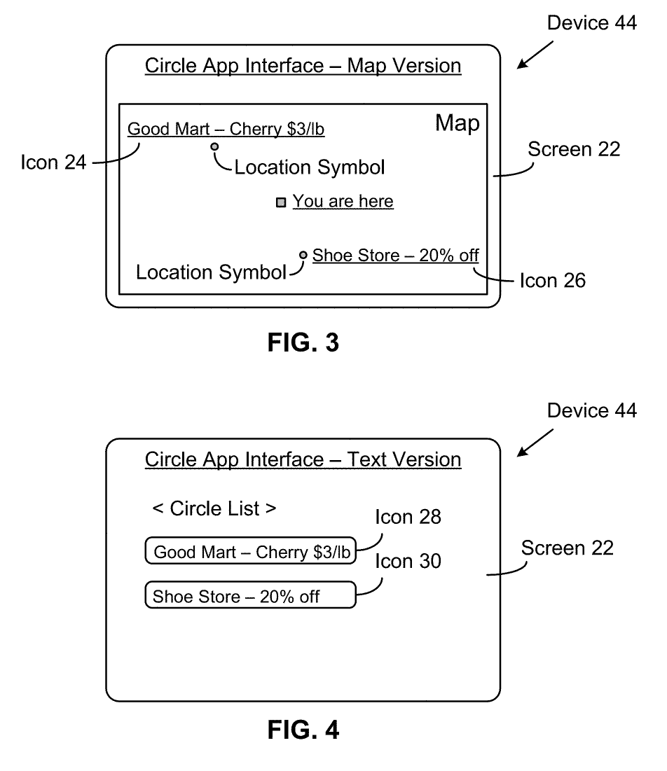

FIG. 2 is a schematic flow diagram showing advertisement via circle app interface and access of store circle. Assume that certain businesses such as retail stores located in Area A want to have their own social networking circles and use the circles to do advertisement. The stores may submit application and needed info at service center. Service center may approve store applications and generate respective store networking circles or store circles in Step 100. Store circles are open to all users without need of invitation, recommendation, verification, and/or registration. After a user arrives in Area A in Step 102, the user may start networking circle app at a user device in Step 104. Then communication between service center and user device may be established. Service center may obtain the user's location that is Area A and send related circle and ad info to user device. Next on a display screen of user device, circle app interface may show store circles which are close by and stores' ads in Step 106. Name of store circle and store's advertisement may be presented using an icon in app interface. Finally in Step 108, the user may select a store circle and tap its icon to access it, assuming that the display screen is touch sensitive. Then a screen view of store circle interface may appear showing the store's products and promotions.

As discussed, circle app interface and circle interface may be employed to present advertisement and product info respectively. Circle app interface is an interface after a circle app is launched. Circle interface is an interface after a user logs in a networking circle. In below discussions, store is used in many cases. Word “store” may be used as an example of business, organization, or government agency. It is noted that word “business” alone covers a wide range of fields, such as retail store, online store, food and dining, services, travel, etc. Advertising principles discussed in one case may apply to other cases.

After a user starts circle app at user device, like a smartphone, an app interface may show up with names and logos of nearby networking store circles. Since there may be quite a few of stores in a region, a screen may become too crowded if each store presents a sizable piece of advertisement. Thus it may be designed that a store or entity may only display limited advertising contents occupying a predetermined area in circle app interface. For instance, a store may only be allowed to display a short ad message within a defined screen area.

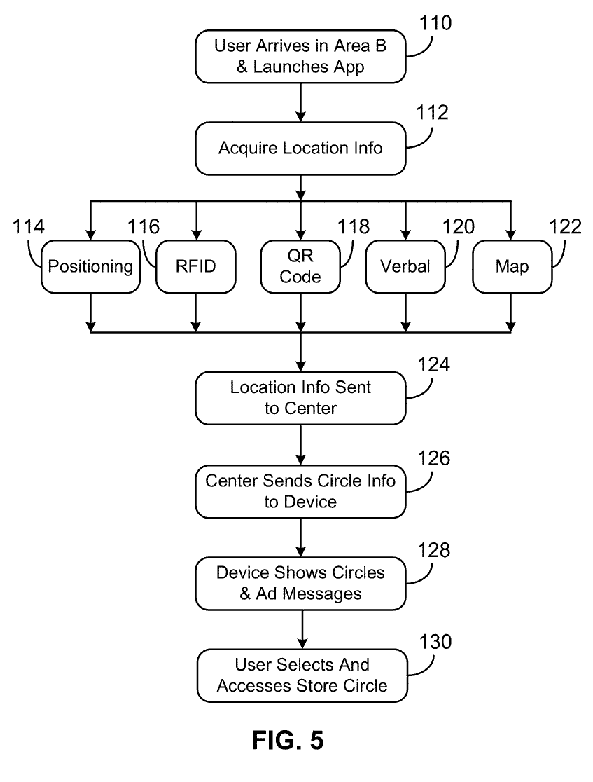

A short ad message may be combined with a circle name and the two may be presented together to show a store has a special on something. For instance, a grocery store named “Good Mart” may have a networking circle with the same name. Assume that circle “Good Mart” shows up in a circle app interface on a screen of user device. In order to help a store present advertisement, it may be designed that a store may add a brief promotional message to its name in circle app interface. The short ad message may be anything that is clear and short. For instance, circle name plus short ad message may look like “Good Mart—Cherry $3/lb”, which is shown schematically on an icon 24 in FIG. 3. FIG. 3 depicts a circle app interface in map mode graphically. In the figure a user device 44 shows a map with title “Circle App Interface—Map Version” on a screen 22. The figure also shows another circle with an icon 26 “Shoe Store—20% off”. It is seen that each exemplary store circle has a small location symbol and an interactive name-plus-message icon. The location symbol indicates store's geographic location. User's own location is displayed on map as well. Store location data may be submitted by store when circle application is filed.

For some business, a logo may be added to form a logo-plus-message icon or logo-plus-name-plus-message icon, making a store icon catchy on screen. After viewing store icons in circle app interface, a user may tap or click on one of them. Next, interface of a corresponding store circle may show up and a user may access circle contents.

FIG. 4 shows a circle app interface in text mode. Shown in an app interface are a title “Circle App Interface—Text Version” and a circle list containing icons 28 and 30. Icons 28 and 30 represent the same store circles as icons 24 and 26 with the same contents. When a user is familiar with stores nearby and there are many stores, text mode may work better than map mode, as icons may be placed orderly on screen. Basically, FIGS. 3 and 4 show the same result in different presentation ways. Buttons may be arranged in the interface for switching between map and text modes. For instance, buttons “Text Mode” and “Map Mode” may be arranged on the two figures respectively (Not shown in the figures for brevity reason). The former button invokes text version of app interface, while the latter switches it back to map version.

Short ad message embedded in an icon, such as “Cherry $3/lb”, may have a length limit or element quantity limit in presentation of single line style. Length limit may mean appearance of short ad message on screen is limited by lateral dimension or width of icon, while icon width may be a value arranged by service center. Since an icon also contains circle name, length of message is smaller than icon width. In addition, maximum element number of short ad message may be set, for instance, at thirty, where elements may include letter, character, single-digit number, sign, image, etc. Ad message is arranged short and brief such that app interface may look neat and a user may catch circle name and ad message easily and quickly. Furthermore, a short message is easier to comprehend than a long one. When a store circle gets a user's attention, the user may tap its icon on screen to log in its circle interface, where more information is prepared. As introduced in the above, contents shown in a circle app interface and circle interface are open to all users. In circle interface, a store may display announcement, promotional info, product info, contact info, and a communication window where eligible users may post comment, message, image, video clip, etc. A store may build a circle interface to present products using images, texts, video clips, and links to store or product websites. Linked websites are designed and managed separately and may be used as a content source for store circle interface, as described in sections below.

A small ad space or ad window with a title “Submit Ad Message” may be arranged in circle interface where anything entered is considered as a promotional message or short ad message. The message may be taken by service center and displayed with circle name in circle app interface. The small ad window makes doing advertisement simple, convenient, and at will. As a store clerk may know, once a short sentence is keyed in and a “Submit” button next to it is tapped, a short ad message may be created and it may appear in app interface in real time. Meanwhile, the short sentence may stay in the ad window for display, reminding store clerk of contents of current ad message. The ad window may be used to adjust ad message in real time as well, since contents entered in the small ad window in circle interface may be transferred to an icon in circle app interface instantly. From technical point of view, after store clerk taps “Submit” button beside an ad window, contents in the window are transmitted to service center. Then, service center sends the contents to users who are close to the store and whose device is showing a circle app interface. Thus circle app interface may be refreshed in time and promotional messages may be updated almost instantly. Hence, a store circle may post or change ad content directly, easily, conveniently, independently, and in real time. The word “directly” may mean a store may publish an ad message in circle app interface without a middle step, like review or approval by any party, and in real time. The word “independent” may mean a store may post and edit ad message in circle app interface, a public domain, by itself, as no outside assistance or approval is needed. “In real time” may mean in a very short period of time, such as within milliseconds or virtually immediately.

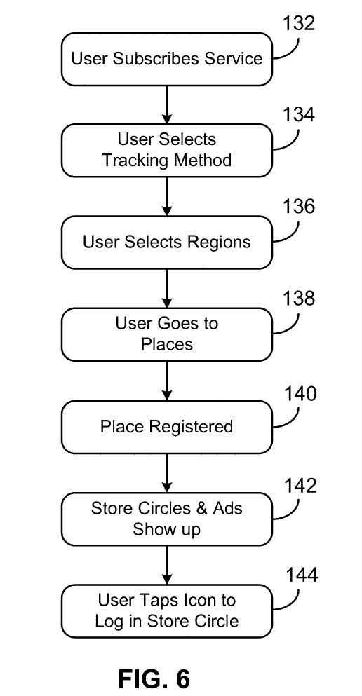

FIG. 5 shows a schematic flow diagram of accessing a store circle and describes various positioning mechanisms. Assume that a user arrives in Area B and launches circle app in Step 110. Next, user device, service carrier, or on-site facility starts to collect location data in Step 112. Depending on program setting, a user may register a place via different methods, since there are several technologies available for location detection. “Register” as a verb may mean a user causes submission of location records to service center actively or passively to provide evidence of being present at a place.

In Step 114, positioning technique such as GPS or triangulation method is used to get user location automatically and directly. GPS method requires a GPS sensor, such as sensor 18 of FIG. 1, while triangulation method may be conducted by on-site facility or wireless service carrier.

In Step 116, RFID technology is used. A RFID tag may be displayed for public use at a place. If a user device has a NFC sensor, like sensor 20 of FIG. 1, a user may swing the device in front of a RFID tag to read it. RFID tag may contain location info and link data so that it may assist a user device to log in a store circle directly. Alternatively, a RFID may be designed as a location indicator, that is, the tag only provides location data to user device. User device then sends the data, as instructed by circle app, to service center to let the center know where a user is.

Step 118 introduces QR code method, which works in a way similar to RFID. The code may contain login instructions for accessing a circle or just info of a location. As a location indicator, RFID tag and QR code may provide precise geographic information. They are especially useful when positioning method is not available, not preferred due to privacy concerns, or not precise enough. But RFID and QR-code methods are not automatic and they require a user to take action, either swiping a device in front of a tag or aiming at and scanning a QR code.

User's location may also be determined by user himself or herself via verbal method as in Step 120. With voice recognition technology, a user may speak to a device name of place or venue. Verbal method is not only useful, but also convenient, as saying a word or a few words is all it takes.

Step 122 employs map method. The method is convenient for on-site users when user location is not precise. For instance, when user location can't be determined accurately enough and there is no RFID tag or QR code printout in sight, a user may open circle app and select map mode. Next, an interactive map may appear on screen. A user may search the map and find a spot of interest. The user then double taps the spot, which may be designed as a confirmation act to specify a location of interest.

With circle app in operation, user's location data is sent to service center in Step 124, after the data is acquired. The center then finds out which store circle or circles should be presented to a user based on location info and predetermined arrangement. It may be designed that a location-based store circle has a defined geographic coverage or designated geographic circle area. Shape and range of designated circle area may be defined by service centre or proposed by a store which a circle is assigned to. When a circle area is submitted by store, service center may evaluate it and approve it with or without any change. If a user's location is in a circle's designated area, the circle may be selected and presented to the user. Since store circles' designated areas may overlap, a user may be located at a place claimed by multiple circles. In such a case, multiple circles may be presented to a user who may review these circles and select one to log in for more information.

Alternatively, a designated geographic user area or designated user area may be defined. All store circles whose location is in a designated user area may be considered relevant to a user and may be chosen and presented to the user. A designated user area may have any shape and dimension specified by service center or user. For instance, a designated user area may have a circular shape whose center is of user location. A circular area's radius may be defined by service center as a default setting which may be adjusted by user later on. Examples of radius value may include one mile to ten miles. If radius is of one mile, store circles whose location is within one-mile range may be picked up and provided to user. It is noted that store circles may be presented in map or text mode at user device. In map mode, a map may show up which covers a designated user area. The map may have square, rectangular, or another shape. In text mode, interactive store icons may form a list or appear on a list as shown in FIG. 4. It is noted that interactive icons of store circles may show up with or without a short message, since some stores may not do it sometimes.

After retrieving info of store circles, service center may send it to user device for presentation purpose in Step 126. Then in Step 128, user device may display icons of store circles, i.e., circle names and short ad messages may be presented in app interface. A user may glance at the app interface and ponder which nearby store looks interesting. Next, the user may tap an icon to log in a store circle in Step 130. If a user is busy, the user may access a circle at a later time. As circle info is received at user device, it may be stored for a given period of time, say a week. An interactive “History” button may be configured in circle app interface. Once a user taps “History” button, circles encountered and recorded within a defined time frame, may appear on screen. A user may tap a circle icon to enter the circle.

FIG. 6 shows an exemplary flow diagram of displaying ads and accessing store circle from another angle. In order to participate in activities of location-based store circles, a user may start by opening an account or subscribing networking service at service center in Step 132. The procedure may be required for users who like to have location-based promotional information conveniently. It may also be required if a user wants to issue post in store circles. If a user is not registered, he or she may still get the same location-based info, with more steps though. For instance, a user may log on a website of service center, find a place on a map, and view store circles and ad messages after zoom-in. Using the same method, all online users may visit service center website, find a store circle on a map, and tap on it to access contents of the circle. Thus store circles discussed here are configured open to all users. However, only registered user may be allowed to post contents on store circles. In addition, whether or not to allow users to post in a store circle may be determined by each store. Some stores may not permit posting by users due to administrative issues.

When a user is interested in location-based networking service, the user may download a circle app from service center website and install it at user device. Service center may create or arrange the app and upgrade it regularly. During app installation, a user may be asked to submit info such as name, email address, place of residence, and preferred user name. As a result, service center may know a user's identity and other personal info, and thus may be able to help the user log in store circles and certain other social networks without another round of registration process and without password entry. Consequently, a user may carry a user name registered at service center and use it in various participating circles. The arrangement makes certain social circles free of registration and in the meantime, a user doesn't need to create user name for every circle encountered. When a user doesn't want to use registered user name in a circle, the user may choose an option to get a temporary user name assigned for use in that circle.

In Step 134, a user selects options of tracking scheme. As location data is a critical part of circle program, a user may decide which detection method would be employed. Location data contains sensitive personal information, so some users may be concerned about privacy leaks. For instance, some may not want service center to know all places he or she has been to. As a result, automatic positioning method like GPS and triangulation may be turned off by some users, while manual operation such as RFID, QR code, verbal, or map scheme may be selected, which means location records are collected and reported only after a user initiates it. In practice, a user may place a user device close to a RFID tag to read it, arrange a phone camera to aim at a QR code to scan it, speak to a user device, or tap a spot on a map.

Next user device may transmit location info to service center. When GPS method is selected and GPS device is turned on, circle app may acquire location info and send location data to service center automatically, assuming the circle app is started already. After receiving location data, service center may use it to retrieve names of relevant store circles along with promotional messages from some circles. It is noted that not every store circle carries a promotional message. So, a circle app interface may display store icons with or without a short ad message. After retrieval process, circle info may be transferred to user device subsequently. If triangulation or other positioning technology such as ultrasonic method is selected, user's location data may be collected and sent to service center automatically from a contracted service, still assuming a circle app is on. When a circle app is off and a user arrives at a place, a user device may not communicate with service center and submit or help submit location records. But a user may authorize a service provider or service facility to collect his or her location records and transfer the records to service center. Thus whether a circle app is on or off, places may be registered and circle info may be stored for future use automatically.

In Step 136, a user selects regions of interest. As a user may pass many places on a routine basis, a lot of store circles may be registered regularly. A user may like some circles, but pay less attention to some other circles. So there is a need to avoid registering certain places and limit the quantity of circles in daily life. A user may single out some places or regions and stay away from circles associated with those locations. After a user delists a place to avoid it, corresponding store circles may not appear even the place is registered by a user.

As a user goes out in Step 138, commuting to work or doing things after work, he or she may register places automatically or manually. Assume that a user turns on circle app and registered a place in Step 140. Then icons of store circles may show up in app interface on device screen in Step 142. As discussed, circle icons may contain circle name or circle name plus logo. When a store does promotions, a circle icon may display a short ad message. Store circles presented in app interface are selected by service center based on location info of user and circles. After a while, if the user goes to another place, circle icons may be replaced automatically by another batch corresponding to the new location. In Step 144, a user may tap a circle icon, which prompts user device to send a message to service center. Service center may start retrieving info of the circle and pass it to the device. Next, a circle interface may appear at user device and circle contents become accessible.

FIG. 7 shows a schematic flow diagram of store circle formation and administration. Assume service center is in charge of social circle creation and management. When a store wants to have a location-based store circle, the store may log on service center website and file an application. Info required for application may include store name, address, contact info, person responsible for store circle, business license number if available, proposed circle name, and so on. Service center may review application data and approve a store circle and its name. As circle name appears at circle app interface, it should be short, have an element quantity limit, and resemble the store name. Then service center may assign a circle to the store along with account number and temporary password. Service center may approve multiple applications from a region and assign circles to respective businesses or stores, as in Step 146.

When circle application process is completed, both store and service center may make the news public. A store may display signs in store to encourage customers to visit the circle online. As store circles may be managed by service center, the center may monitor activities of store circles in Step 148. For instance, when a store changes certain circle contents, service center may make update at center's database.

In Step 150, service center receives request for circle info from an on-site user, which may happen after the user launches circle app. Start of circle app may mean a user is looking for store circles and promotions nearby. User request and location info may be transmitted to service center automatically by instructions from circle app. Next, service center performs a search based on data received to get info of relevant circles and short ad messages which may be attached to certain circles. Then in Step 152, service center sends circle and ad info to user device, which may be presented in a circle app interface for user to review. A user may take a look at the interface and tap a circle icon to select it. Next in Step 154, service center receives selection info from the user. In Step 156, service center retrieves data of the selected circle from database. Circle data is then transmitted to user device for presentation in Step 158. Finally in Step 160, user device, as directed by circle app, displays a circle interface based on data received from service center.

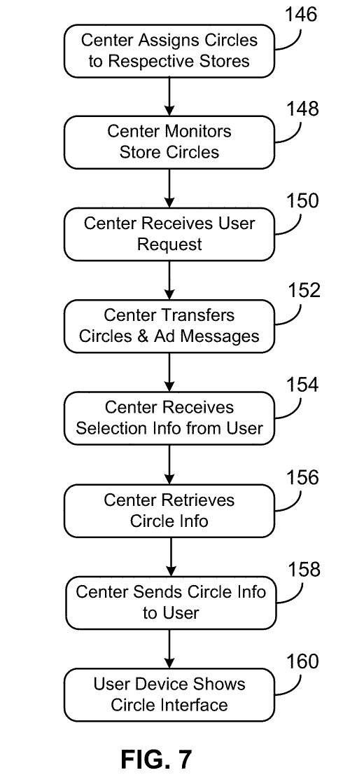

FIG. 8 uses graphic diagrams to show access of store circle. Take a smartphone 32 as user device. Assume the phone shows some apps in an interface. A user may tap icon “Circle App” to launch the program in Step 1. Then the app gets started and sends a message to service center. The message may contain location data and a request for circle info nearby. After receiving circle info from service center, phone 32 shows a circle app interface in Step 2. There are two store circles showing up on a map, one with a short ad message “7% off”. Circle location and user location are also displayed. Next in Step 3, the user selects store circle “Bon” and taps its icon on screen. The phone receives the input and sends the info to service center via algorithm of circle app. Service center then retrieves info of circle “Bon” from database and transmits it to the phone. Next, phone 32 obtains new info and uses it to present a circle interface of “Bon” in Step 4. The user may view products, promotions, and comments from other people from the interface. Thus, it is seen that accessing a store circle is simple, easy, and convenient for onsite user. No registration. No password. A user may start a circle app, view info from stores close by, and then choose a store to find more details.

When a user's location is known, a circle app may show a map covering the location in app interface. A corresponding map area may be specified by service center, circle app setup, or user selection. The map area may be of a designated user area which is discussed in the above or may overlap a designated user area with certain degree. For instance, if a designated user area is circular, a map may show the exact circular area or a square which covers most of the circular area.

A map area in a starting app interface may also be an area which is large enough to include locations of local circles, where a local circle may mean a store circle whose designated circle area covers a user's location. Setup of map area in starting interface may be edited by user. For instance, a user may change shape of map area from square to rectangular. After a map area is determined, service center may retrieve all circles whose location is in the area and send circle information to user for presentation. On user device side, info from service center may be received and then displayed in an interface as instructed by circle app. For instance, a map dotted with circle icons may be presented on a screen.

As discussed, a user may access nearby social circles conveniently after arriving at and registering a place. Such a user may be called “local user” for those store circles. But a store circle may also be accessed by users who are not there, whether registered or unregistered. These users may be called “remote user”. A remote user may be close to the place or thousands of miles away from it.

More specifically, it may be defined that a user is considered local user for a store circle if the user is physically located in the circle's range or designated circle area. When a user is located out of the designated circle area, the user may be considered as remote user to the social circle.

For a store, it may be important to know the quantity of checked-in local users, which may reflect a potential customer base. “Checked-in users” may mean users who have submitted location data, the same as users who have registered a place. Thus it may be designed that quantity of checked-in local users may be presented to store circle. For instance, when store clerk logs in the store's own circle interface, which is different from the one shown to the public, checked-in local user quantity may be displayed in the interface. Thus, a store may conveniently monitor number of checked-in local users before making a promotional decision. For instance, a store may have promotions valid for local users only, e.g., only local users may collect electronic coupons of limited quantity.

Since some store circles have no promotional message to present, circle icons may show a circle name or a name plus logo only in circle app interface. On the other hand, some users may like to see promotions and some may not. To accommodate different needs, two interactive buttons, “Ads” and “No Ads”, may be arranged in circle app interface. For instance, when “Ads” button is activated, an interface may only show circles which carry an ad message. Accordingly, all circle icons shown on screen may have a circle name and a short ad message. As some circle icons which don't have short ad message are removed, new circle icons may be retrieved and presented which replace those without ad message. Some of the new circles may not be local circles but are still relatively close, which may not be considered as an issue since sales info may become more important to users when “Ads” option is chosen.

When “No Ads” button is activated, short ad messages in app interface may be removed such that only circle name or name plus logo are displayed. It is noted that circle distribution or lineup is not altered in such a case, while the only change is that some circle icons have less contents. After a user taps a button to show or not to show ad info, circle app or service center may implement it. For instance, circle app may be designed to have a function which may present circle icon with or without short ad message. If it is handled by service center, service center may act after receiving selection info from user. Service center may send data and instructions to user device and cause app interface to show a list of circle icons with features selected. It is noted that an app interface may be in a map mode or text mode. Methods discussed apply to both scenarios.

Moreover, two kinds of icon widths may be designed, a narrow one for name or name plus logo only, and a wider one for name (or name and logo) plus short ad message. Thus, two types of icons may appear in circle app interface. As a result, when “No Ads” button is tapped, all icons become the narrow ones, which may make app interface look neater.

A short ad message which appears in circle app interface may play an important role in store management. The ad message may be created and edited by store clerk directly and in real time. Store clerk may mean a user who is authorized to manage a defined part of contents in a store circle interface and administrate certain activities of store circle. For instance, a store clerk, with permission of store owner, may request service center to create a store circle and assign her or him as an administrator of the circle. Then the clerk may generate and edit short ad message which shows up in app interface. As already shown, a circle icon may contain two parts, circle name, with or without store logo, and a short ad message. Circle name may be fixed and may only be changed with approval from service center. But a short message may be changed independently anytime by store clerk, possibly with a service subscribed. Thus, a store may be able to present ad info in app interface anytime. As discussed, a short ad message may be anything within a length limit or element number limit. Examples of short ad message may look like “Holiday Sales”, “$3 Cheese Burger”, “Next Show @7:00 pm”, etc. Since promotional info may be changed or updated by stores frequently, circle app interface may become a dynamic advertising platform. In a similar way, circle interface may work as a dynamic advertising platform too, since a store may use its circle interface to present products and services. Store clerk may change certain contents in circle interface anytime. For instance, a store clerk may check sales status and adjust short ad message in app interface and other promotions in circle interface in time and on demand.

When a user taps a circle icon in app interface, the circle's interface may appear. As said, a circle interface may contain a communication window where users including local users, remote users, and store clerk may chat and post comments and messages. A store may use circle interface to display various contents, such as text message, table, form, graphic presentation, and interactive icon representing link to specific web page or website. All of these contents may be prepared for introducing products and services, presenting promotions, and displaying advertisement. It may be designed that a store may edit or change self-created contents freely. For instance, promotional info in circle interface may be changed by store based on actual needs and displayed at consumer's device in real time. The reason is that once contents in circle interface are changed, the info is transmitted to service center automatically by circle app algorithm. Then service center may store the info at product database and pass it to user devices which request such info. Circle interface may also be arranged to display contents coming from service center. For instance, a store circle interface may display ads made by manufacturer of a product which is unrelated to the store. A store may be compensated for other's ads shown in circle interface.

In circle app interface, a circle icon may only be allowed to have a small footprint to show one line with limited content, such as “Pizza House: Medium Half Price”. Because sometimes a store may have a need to present more advertising contents, an arrow button may be added and placed next to a circle icon. For instance, a small arrow button may be attached to the right side of circle icon. When an arrow button is tapped, a pop-up window may show up displaying more contents in multiple lines temporarily, where each line may contain an interactive secondary icon showing a short ad message. A user may tap a secondary icon to select a line of interest. After a secondary icon is tapped, the window closes and the circle icon presents the selected message in app interface. For instance, a circle icon may show a short ad message “All Toys 25% off” at the beginning. After a secondary icon “Flexible TV $100 Rebate” is tapped, message of the circle icon is switched to the television rebate. After that, the user may check and change content of other circle icons. Then modified ad messages may show up in app interface. The user may compare sales info on similar products easily and conveniently.

When a user taps an arrow button beside a circle icon, multiple lines may pop up for the user to view and select. But too many lines may make a user feel stressed or confused. Thus there may be a limit for the number of lines in a pop-up window along with length limit or element number limit for each line. The limits may be defined by service center. For instance, maximum line number may be set between five and ten. Moreover, a “Multi-Line” button may be arranged in circle app interface. Once “Multi-Line” button is activated, each circle which is presented in circle app interface may display more lines. When a store circle has a chance to display more lines in circle app interface, more sales items or info may be presented. Store clerk may prepare multiple lines for use in app interface after entering “Edit” mode in circle interface. For convenience purpose, another interactive button such as “Single Line” may be arranged for switching from multi-line to single-line version in circle app interface.

As a default setting, after a circle app is launched, an app interface may show a list of local circles and possibly some other circles whose locations are relatively close by. Some circle icons may contain a short ad message, while others may show circle name only. Sometimes, a user may look for sales of a product and is less concerned on store location. Thus there exists a need to present store circles based on promotional info, product info, or other info chosen by user.

For instance, service center may collect short ad messages which are prepared by stores for display in app interface. Such data is easy to get, since contents of short ad message are transferred to service center after being submitted by store. Service center may receive and collect ad messages from store circles and keep the info at product database. In app interface, a small space may be arranged with a tile “Ad Word”. After a user enters a query word in the space and taps a “Search” button, the query word may be transmitted to service center. Service center may start a search based on the query word at product database. The center may retrieve relevant circles whose short ad messages may be relevant to the query word. Next a list may be sent to the user and the list may show up in circle app interface. On the list, each line may display a circle name plus a short ad message. The messages may contain relevant information. Thus, a user may look at the list, recognize familiar stores, and compare discount info conveniently. It may be designed that, when service center does a search, it only selects stores whose location is within certain range of a user, say ten to fifty miles. Search range may be adjusted by user and a new search may take place after a new range value is entered.

Furthermore, online stores may be included in a search process too. Online store is a store which doesn't have a retail space for people to visit physically, look at real products, and shop there. In discussions here, a word “store” as noun may mean a physical store or retail store. When an online store wants to be included in a search, it may register at service center and get approval for serving a certain region or multiple regions. Online stores may carry a special mark to differ from physical stores when showing up in app interface, so users may know right away whether it is an online store or retail store.

Since some users may prefer shopping at physical store and some prefer online store, there exists a need to provide different options in a search process. For instance, small check boxes “Retail Store Only”, “Online Store Only”, “Retail & Online Stores” may be arranged in a circle app interface. The boxes cause display of different search results in circle app interface respectively. When “Retail Store Only” box is checked, for instance, search results may only contain circle icons of retail stores. When “Online Store Only” box is selected, search results may only show circle icons of online stores. When “Retail & Online Stores” box is selected, search results may cover circle icons of both retail and online stores.

For users who frequent certain stores regularly, there exists a need to group the stores together for checking promotional info from them conveniently. It may be designed that a user may tap “Edit” button to enter “Edit” mode in app interface, tap “History” button to display a list of store circles, and then select some store circles to form a group. A user may assign a name to the group. Group info is sent to service center and recorded as part of user data at user database. In app interface, a “Group” button may be configured. After “Group” button is tapped, a list of group names may show up. A user may tap a group name. Next group selection info is transmitted to service center. Service center gets circle names from user database. Then info of circles in the group is retrieved from product database and sent to user device. After receiving circle info from service center, user device displays a list of circle icons in an app interface. As introduced in the above, a circle icon may contain a circle name and a short ad message. A user may glance at a list of familiar store names, check short ad messages, and make a decision to go to a store or tap a circle icon to learn more info.

Before going to stores to make purchases, some users may like to have more info on product such as brand, quality, and origin place or place of manufacturing. Thus, there exists a need for users to obtain such info easily and a need for stores to provide it conveniently. For instance, after a store clerk taps “Edit” button to enter “Edit” mode in circle interface, the clerk may go to “Data Entry” section to key in product information including model number, version number, brand, manufacturing or producing place or country, quality status, pricing info for selected items, etc. The section may have a data entry format which is designed by service center. For instance, a data form or table may be prepared to show up on screen for store clerk to fill in and upload files. Contents of data form or table may be transmitted automatically to service center and kept at product database after store clerk taps a “Done” button to conclude an editing process. A data form or table which contains product info may be displayed in store circle interface for public use. So a consumer may access store circle interface to view product info in certain depth. Due to limited screen space, only part of product info that store clerk entered may be displayed, while the rest may be reached by scrolling down, turning page, tapping a link, or other actions.

To make it simple for stores, it may be designed such that circle app may retrieve data from a designated file or website, where the circle app is designed for store or business use and thus is different from circle app created for vast individual users. For instance, after a store clerk enters “Data Entry” section, a “Data Retrieval” button may be arranged in circle interface. Algorithm of circle app may be designed that after “Data Retrieval” button is tapped, circle app may search a pre-selected file or website for product and other info and fetch related data automatically. For instance, a small space with a title “Designated File/Website” may be arranged in circle interface, where store clerk may select one or more files in store computer system or enter one or more website addresses. Then address info of selected data source may be recorded by circle app and used when needed or instructed to do so.

Circle app may import data from selected sources when constructing a data form or table in circle interface. A data form or table may be configured in a screen area or window called product showcase. Broadly speaking, a product showcase may mean a designated area in circle interface for store to present products and services. The showcase may contain forms, tables, texts, images, video clips, and links to webpages. While store clerk may create contents for a showcase manually, it is more convenient if existing files and webpages may be utilized. A store may use its website to build a product showcase in circle interface, For instance, store clerk may choose a circle app function such that certain contents from a website are transferred to circle interface. One exemplary scenario is that a showcase window may be created in circle interface. Contents and functionality of the showcase window may copy that of the store's webpages either partially or fully. Thus a user may click or tap links or items in circle interface like clicking or tapping them on a webpage. The method makes good use of store's existing resources and provide for users with detailed info and user-friendly formats.

Store clerk may also import data selectively when building a product showcase, since some stores may only want to publish part of product info in circle interface. For instance, store clerk may select a file and then open it via circle app. After a file is open, store clerk may select certain part of it and import the selected portion only. A pre-selected file may be an inventory control document or inventory record file at a store. As a store may make changes from time to time, it may be designed that circle app may check contents of the pre-selected file or website periodically, say in half-hour, one-hour, or two-hour time interval, or at certain time slots chosen by store clerk. If any change of the pre-selected file or website is found, circle app may make change in product showcase accordingly and automatically and then the info is sent to service center. Alternatively, store clerk may change certain contents manually. Again, after the change is made, related info is sent to service center. Thus product info and other contents presented in circle interface may maintain updated either automatically or manually. As any change of content in circle interface is transmitted to service center instantly, service center may be able to keep and provide updated info continuously.

Meanwhile, a store circle interface may have its own advertising area. For instance, a check box may be prepared for each item in product showcase which indicates whether an item is selected for advertising area in store circle interface. Store clerk may check a box and then a corresponding item may appear in store advertising area automatically. In the area, store clerk may enter for each item a short promotional message, like “20% off”, “New Arrival”, “½ Price After 5 pm”, etc. The advertising area is arranged open to the public. Thus a consumer may have an overall view of promotions at a store easily. As other data entered in store circle interface, all contents in store's advertising area are sent to service center automatically after they are submitted. Service center may store the info at product database. Such info may become useful when users search for advertisement info among stores.

As discussed, for management of short ad message in app interface, a small ad window may be arranged in circle interface, which may have a title like “Submit Ad Message”. Content entered and displayed here is the one which shows up with circle name in app interface. Thus store clerk has a clear view of what appears in app interface. A “Submit” button may be arranged beside the small window. Once the button is tapped, content in the window is transmitted to service center, which then sends updated info to relevant users. When multiple messages are allowed in app interface, store clerk may determine the order of short messages, such as which item is placed at the first place, which is at the second place, and so on. Message at the first place is chosen for display in app interface in single-line mode or chosen for display in the first line in multi-line mode.

One aspect of product info is of quality. Quality status may be represented by, for instance, number of stars, like one to five stars with five stars standing for the highest quality. Quality status may be determined by a vendor, manufacturer, producer, or store clerk. Another aspect of product info is of pricing and promotion, such as regular price, discounted price, and special offer. After store clerk submits product info in “Edit” mode, the data may be transmitted to service center automatically and aggregated in product database.

Service center may collect product info, short ad messages, and other info from store circle interface, and keep the data at product database. The data may be used in search process. Search may be categorized by brand search, origin search, and quality screening besides promotional info search. For instance, a “Product” check box may be arranged in circle app interface. A user may check the “Product” box and enter a product name and brand name in an entry space next to the “Search” button and then tap the button. When service center receives inquiry info, a search may be launched at product database. Service center may search a group of circles which are within a certain range of user or within a range specified by user. Next, info of selected circles is sent to the user. A list of circles may be arranged to appear in app interface of user device, where each item on the list may contain a circle name, product name, and brand name. A user may tap a circle name to log in circle interface to get more info.

In addition, “Origin” and “Quality” check boxes may be configured in app interface. A user may check “Origin” box and enter a query containing product name and a place or country name to get a list of store circles which carry products from the place or country. A user may also check “Quality” box and enter a query containing product name and star rating to get a list of store circles which have the product with specified quality or higher quality. For instance, a user may check the box, key in “cherry” and “3”, and then tap “Search” button. The info is sent to service center which may search product database and retrieve circles which carry three-star, four-star, and five-star cherries. Info of selected circles is then transmitted to a user device and displayed in circle app interface. In an app interface, each result item may show circle name, cherry brand, and star rating.

Service center may get notified and receive info automatically once store clerk submits or changes product info or other content in store circle interface. The auto data transmission may be carried out by circle app which is designed for store use and installed at a store device, like a smartphone or tablet computer. Service center then adds the info to product database. Such info transfer and sharing mechanism enables service center to update contents at product database and serve users with the newest data in real time. Resultantly, it may also enable service center to provide users with updated information continuously.

When doing a search, a user may specify a geographic region which may be small or large, close by or far away, domestic or worldwide. Without region selection, a default setting may be a circular area with a radius of, for instance, one to twenty miles. A small input space with a title “Range” may be configured in app interface. A number as radius and/or a place name may be entered in the space before a search, which may be taken when query data is collected. A place submitted may be a geographic center of a search. It may also be designed that geographic range used in a search is automatically adjusted based on the quantity of search result. When there are plenty of search results within a default range, say more than ten items, a search may be conducted in a default range only. But when there are fewer results than a given number within a default range, search range may be expanded automatically until a given number of results are obtained. For instance, assume that a default range only covers five miles. Then the range may go beyond that automatically when quantity of search results is below a given value.

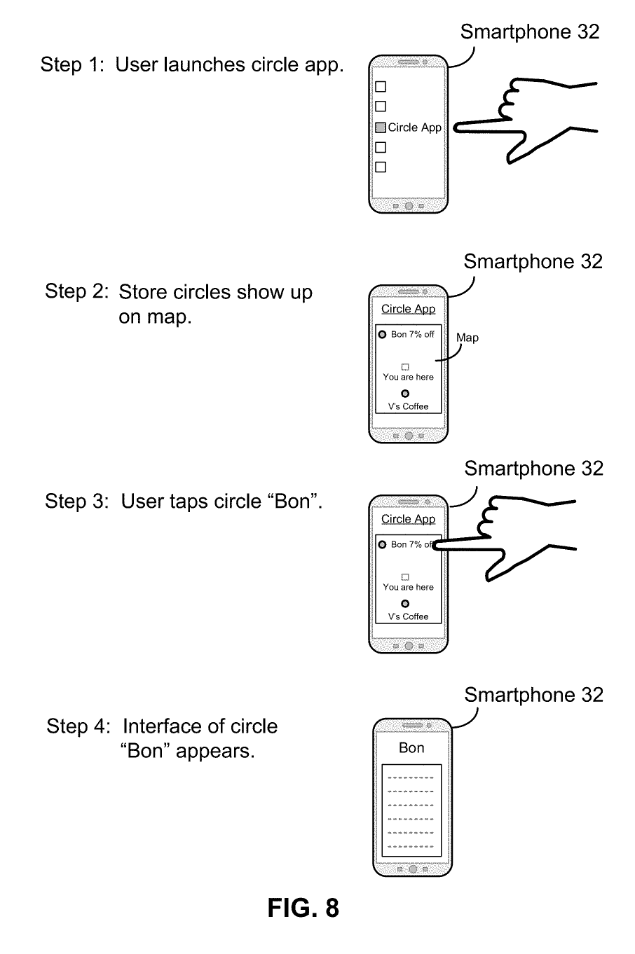

In the above, a number of circle icons are arranged in app interface, where each circle icon may contain a circle name and a short ad message in a single line. As icon space is limited, the message may only contain info related to price cut or promotion. However, when a user looks for a deal, the user may want to know more besides pricing info. Thus another option may be arranged which allows each circle to present more contents in app interface. As shown in FIG. 9 for instance, an app interface is presented on a screen 36 of a device 34. Circles “Good Mart” and “Shoe Store” present multiple lines using icons 38 and 40 in text mode. The first line of icon may just show a short ad message as discussed before. The second line or second and third lines may display product brand, quality, origin, etc. For instance, icon 38 shows that cherry is produced at North Farm and has three-star quality, while icon 40 shows that discount applies to all brands and all products are made in Napa with four-star quality. Comparing to FIG. 4 where icons 28 and 30 are displayed, icons 38 and 40 in FIG. 9 present more details. For switching between single-line and multiple-line styles, buttons “Product Info” or “Single Line” may be configured in app interface for each case. As FIG. 9 shows icons containing multiple lines, a “Single Line” button 42 is arranged. When button 42 is tapped, the format is switched to single-line version which may look like what is shown in FIG. 4. Vice versa, when “Product Info” button is tapped in an interface showing single-line icons, each icon may be replaced by a new one having multi-line contents.

It is noted that methods introduced for dealing with app interface and circle interface and various search methods may apply to networking circles assigned to all kinds of businesses, organizations, and government agencies, or even to individual users. In an app interface, relevant entities may have their own networking circle icon in display, which, when activated, may lead to a corresponding circle interface where contents and promotional info may be in display. As discussed, any user including business and organization may file application at service center to set up a networking circle. Once a networking circle is operational, data may be entered by applicant or store clerk to introduce and promote products, services, events, or any subject advocated by an entity. Data submitted by store clerk is sent to service center automatically by algorithm of circle app. Data is then stored at product database at service center. After data is in place at product database, it becomes searchable and available to all users. Therefore, a networking circle interface may function as a data feeding station as well as an advertising platform to show products, services, and events to all users. When a user needs to know anything, the user may open a circle app, key in query words, get a search result from service center, and then find more info in a circle interface.

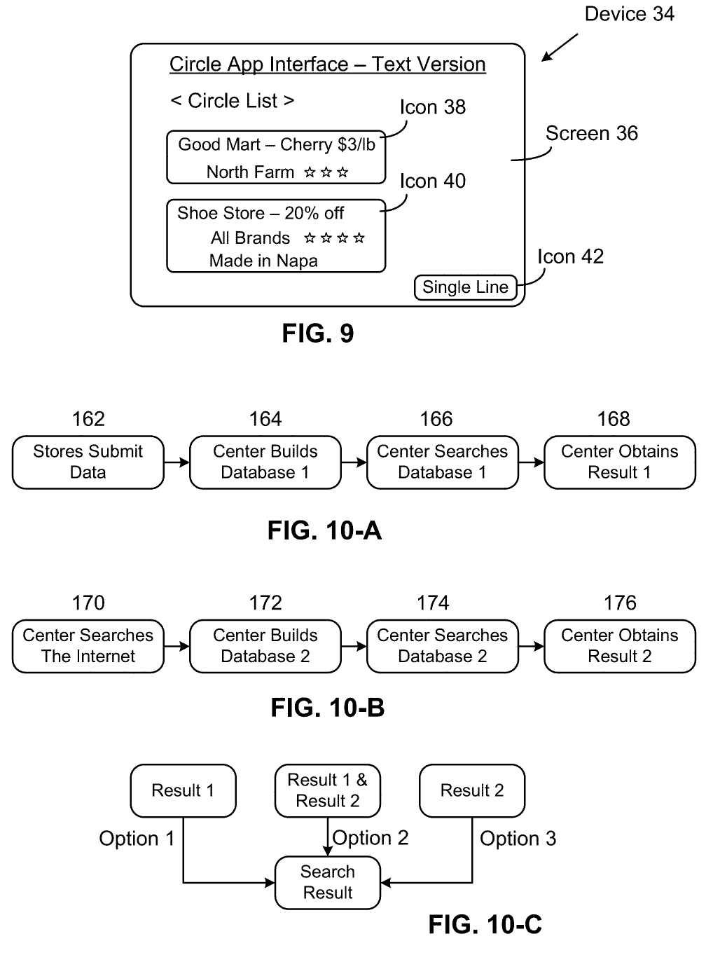

FIG. 10-A shows a schematic flow diagram which describes a search method. It starts from Step 162 where store clerks submit data such as product info and short ad messages via circle interface respectively. The data is then transmitted to service center which uses it to build Database 1 in Step 164. Database 1 only contains data collected from store circle or circle interface. After service center receives a search query from a user, it conducts a search at Database 1 in Step 166. Next in Step 168, Search Result 1 is obtained from searching at Database 1. Since the search is performed at Database 1 where data is gathered from circles under supervision of service center, it may be considered as an internal search using internal data. In comparison, FIG. 10-B shows a schematic flow diagram of another kind of search process. It begins from searching info on the Internet in Step 170, which involves mature and conventional method as demonstrated by search engines employed at a few well-known websites. Next in Step 172, service center compiles data to build Database 2. After a user hands in a search query, service center searches Database 2 in Step 174. Then, Search Result 2 is generated in Step 176. Result 2 is obtained from searching data at Database 2 and thus is based on info collected from sources on the Internet. FIG. 10-C shows exemplarily three ways to generate a search result. In Option 1, it may be designed that a search result only contains Result 1, i.e., info from networking circles only. In Option 2, a search result contains both Result 1 and Result 2, a combination of internal search and Internet search. In Option 3, a search result contains Result 2 only, i.e., a conventional result. Options, represented by check boxes, may be configured in app interface so that a user may check a box to select among the three choices when conducting a search. Buttons may also be arranged so that a user may tap a button to get search result of another option without starting search process from the beginning.

It may be designed that when a search is carried out, Result 1 is presented at user device at first. If a user wants to know more, the user may tap an “Add Internet Data” button. Next, Result 2 may be obtained, combined with Result 1, and presented on screen together. For instance, assume that Result 1 contains a list of five lines of store circle. Initially, there are five lines on screen after a search process is completed. Then a user taps “Add internet Data” button. Next, Result 1 and Result 2 are combined and appear on screen together, with the latter following the former and starting from the sixth line. It may provide convenience when more info is desired. In case Result 1 contains a long list, Result 2 may be added after a given line, or part of Result 2 may be inserted between two given consecutive lines of Result 1. When circle interface presents both Result 1 and 2, two buttons “Circle Info Only” and “Internet Only” may be arranged in app interface. A user may tap one button to view results from one source exclusively.

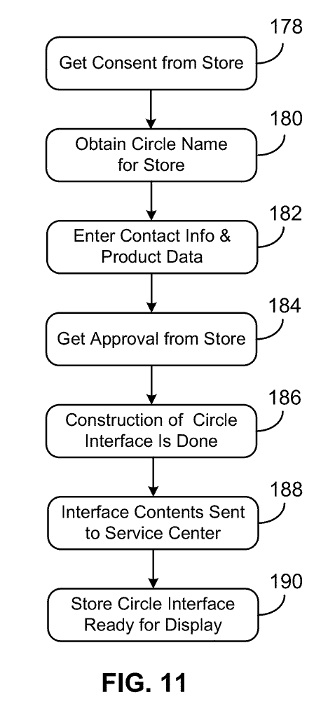

For some stores, setting up a store circle interface may look intimidating due to lack of knowledge and skills. Thus, there exists a need to assist stores to build a circle interface. FIG. 11 shows a flow diagram to describe schematically a process to help a store create circle interface. In Step 178, a representative of service center may contact store clerk, invite the store to join a circle plan, and get consent to build a circle interface for the store. First, the representative may create a circle name for the store in Step 180. A circle name may be arranged to be the store name if it's distinctive enough and not very long. Otherwise, a circle name may be created. It may contain some elements which are related to the store name. An ideal circle name is what users may easily recognize and relate to a store.

Next in Step 182, the representative may install circle app at a store device. Service center may arrange two kinds of circle app, one for regular people and the other for store or business. Circle app for store use enables a store to input and edit interface contents after login of store account. When app installation is completed, the representative may key in or upload data to generate contact info and construct a product showcase. If a store doesn't want to have product showcase, the step may only contain input of contact info. When uploading data, a representative may use the circle app to search and get info from electronic files provided by store or get info from store's website. Then the representative may show a finished circle interface to and get it approved by store clerk in Step 184. Once approval is obtained from store, construction of circle interface is completed as in Step 186. Next, as designed, interface contents are transmitted to service center by circle app instructions in Step 188. As discussed in the above, service center may receive data sent from store and keep it at product database. Finally, a store circle interface becomes ready for display and public use in Step 190.

For certain stores, a circle interface may be replaced by the store's website, i.e., after a user taps a circle icon in circle app interface, a screen may show a store's existing webpage, instead of a circle interface provided by service center. Certain stores may prefer such an arrangement as it may save cost on content management. To accommodate such use, for instance, a button “Webpage as Interface” may be configured in store circle interface. A small space may be configured beside the button for entering address of a selected webpage. After the button is tapped, a message may be sent to service center so that users may be directed to the selected webpage. Meanwhile, a store circle interface may become much simplified, as there is no need to display contents. The interface may display an image of the selected webpage as a reminder for store clerk. Since a regular webpage doesn't provide a short ad message for app interface, the small ad window may remain in circle interface for the purpose of submitting short ad message for app interface. A button “Cancel Webpage Show”, for instance, may be arranged in the interface. Store clerk may tap the button to cancel connection between circle icon in app interface and a webpage. Once the button is activated, users are directed back to store circle interface.

### CONCLUSION, RAMIFICATIONS, AND SCOPE

Thus it can be seen that systems and methods are introduced to provide improved advertisement using location-based open social networks.

The improved method and system have the following features and advantages:

(1). Location-based store circles are arranged for stores or businesses;

(2). Ads from nearby stores are presented to users;

(3). Multiple short ad messages are presented in circle app interface;

(4). Stores may create and edit short ad message easily, freely, directly, and independently;

(5). Stores may edit and post short ad message in networking system in real time;

(6). Users may search product and promotion info collected from store circle interface; and

(7). Contents in circle interface may be updated automatically.

Although the description above contains many specificities, these should not be construed as limiting the scope of the invention but as merely providing illustrations of some of the presently preferred embodiments. Numerous modifications will be obvious to those skilled in the art.

### Ramifications

A user may speak to a device to enter instructions using voice recognition techniques. For instance, after a user arrives at a place, the user may say “circle app” to a device to launch a circle program. Next a circle app interface may show up on screen with icons of store circles presented. The user may take a look at the icons and say a circle's name to enter it.

Besides business and organization, an individual user may also file application at service center to set up a networking circle. A circle may be arranged for group event or personal use.

As discussed, store clerk may tap “Edit” button to enter “Edit” mode in circle interface. Then the clerk may enter “Data Entry” section by activating a “Data Entry” icon. In the section, a data input form may be arranged that provides convenience for keying in data. The data may be related to product, service, event, etc. As businesses and organizations may have their unique requirements, there exists a need to prepare different data input forms accordingly. For instance, forms may be generated exclusively for retail store, online store, restaurant, transportation company, private or public venue, manufacturer, service, service provider, government agency, and so on. For restaurant, product name may be of dish name or name of menu item. For service provider, program name or service name becomes product name. For hotel, product names are of various rooms available. For websites selling airline ticket, product names may reflect tickets from a place to another place.

Sometimes users may prefer shopping online without physically visiting a retail store. As a result, some retail stores may arrange online purchase function in circle interface. Online transaction and payment technologies are mature and widely used at many websites. It may be designed that for store circles providing online purchase function, a label with words like “Online Order” may be attached to circle icon. Hence, users may easily tell which circle handles online transactions. For users interested in online stores, “Online Store Only” button may be arranged. Once tapped, the button may lead to display of online shops only.

Since some stores have online ordering capability and some don't, an “Online Order Only” button may be arranged in circle app interface. A user may activate it to remove from screen store circles which don't offer online ordering. Thus an app interface may be arranged to only display store circles which have the capacity. Additionally, a “Default Config” button may be arranged in app interface for returning to screen view of default configuration.

In circle app interface, a circle icon may be allowed to show a short ad message. But sometimes, an image may enhance ad effect. So, a specific small button may be arranged beside a circle icon. Once the button is tapped, an ad image may show up. The image may be big enough to display detail of an object or scene, say as big as a quarter or half of screen size. In order to upload image data, a file button may be arranged beside the small ad window in circle interface. Store clerk may tap the file button to start finding and uploading image data.

In above discussions, “tap” as a verb is used as an action to activate an interactive icon or button on screen. It is noted that tapping action may be replaced by other suitable moves, like clicking, verbal instructions, or gesture instructions. Verbal and gesture instructions may play an important role when VR and AR devices are involved. For instance, a user may verbally ask a VR or AR device to start a circle app, show store circles nearby, and display a circle interface with mature voice recognition technology.

All discussions in app interface may be suitable for both map and text modes without specific mentioning in many cases, as the main difference between them is of presentation style,

Lastly, in aforementioned discussions, QR code may be replaced by other machine readable code without affecting proposed functionality, such as one-dimensional bar code, as long as the code contains info required and is readable by user device.

Therefore the scope of the invention should be determined by the appended claims and their legal equivalents, rather than by the examples given.

1. An apparatus having stored executable instructions, comprising:
1) at least one computing system being operable to implement a social networking system, the social networking system arranged to implement a plurality of social networks, the plurality of social networks each arranged to be associated with a location;
2) the social networking system arranged to have positioning solution for obtaining location data of a user;
3) the social networking system arranged to select one or more of the plurality of social networks based on their location info and the user's location info, the selected one or more social networks including a networking circle;
4) said social networking system arranged to present one or more icons representing the selected one or more social networks in a networking interface on a screen of user device; and
5) the one or more icons each showing a network name, at least the networking circle's icon showing a message, wherein the message is created by the networking circle and is arranged to be editable directly and independently by the networking circle.

2. The apparatus according to claim 1 wherein the message is arranged to have a length or element quantity limit.

3. The apparatus according to claim 1 wherein the selected one or more social networks are presented on a map.

4. The apparatus according to claim 1 wherein the message is presented in a single line.

5. The apparatus according to claim 1 wherein the one or more icons are arranged to be interactive on the screen.

6. The apparatus according to claim 1 wherein the one or more icons each represent an option to log on a corresponding social network.

7. The apparatus according to claim 1 wherein a space is arranged in the networking interface for entry of search query by a user.

8. A computer-implemented method, comprising:
1) configuring a plurality of social networks using a networking system;
2) the plurality of social networks each arranged to be associated with a location;
3) obtaining location data of a user;
4) selecting one or more social networks based on location info of the user and the networks, the selected one or more social networks including a networking circle;
5) presenting in a networking interface the selected one or more social networks, wherein each of the selected one or more social networks is represented by an icon;
6) obtaining a message from the networking circle; and
7) presenting the message on an icon which represents the networking circle, wherein the message is arranged editable by the networking circle directly and independently.

9. The method according to claim 8 wherein the message is arranged to have a length or element quantity limit.

10. The method according to claim 8 wherein the selected one or more social networks are presented on a map.

11. The method according to claim 8 wherein the message is presented in a single line.

12. The method according to claim 8 wherein icons of the selected one or more social networks are arranged to be interactive in the networking interface.

13. The method according to claim 8 wherein icons of the selected one or more social networks each represent an option to log on a corresponding social network.

14. The method according to claim 8, further including configuring a space in the networking interface for entry of search query by a user.

15. A computer-implemented method, comprising:
1) arranging a plurality of social networks including a networking circle using a networking system;
2) configuring a first interface at a first user device showing icons of the plurality of social networks, wherein the icons are arranged to display names of and messages submitted by the plurality of social networks respectively;
3) configuring a second interface at a second user device showing a plurality of contents which are provided, edited, and controlled by the networking circle;
4) configuring a space in the second interface, the space arranged for entry of a message by a user and display of the message in the second interface;
5) obtaining the message from the space in the second interface; and
6) presenting the message using the networking circle's icon in the first interface.

16. The method according to claim 15 wherein the message is arranged to have a length or element quantity limit.

17. The method according to claim 15 wherein the message is presented in a single line.

18. The method according to claim 15 wherein the icons are arranged to be interactive in the first interface.

19. The method according to claim 15, further including collecting the plurality of contents from the second interface and store collected data in a database.

20. The method according to claim 15, further including presenting a search option in the first interface.
